(19) United States
(12) Patent Application Publication
(10) Pub. No.: US 2023/0272132 A1
(43) Pub. Date: Aug. 31, 2023

(54) SOLUTION PHASE POLYMERIZATION PROCESS

(71) Applicant: NOVA Chemicals (International) S.A., Fribourg (CH)

(72) Inventors: Peter Zoricak, Calgary (CA); Brian Molloy, Airdrie (CA); XiaoChuan Wang, Calgary (CA); Lawrence Van Asseldonk, Sarnia (CA)

(73) Assignee: NOVA Chemicals (International) S.A., Fribourg (CH)

(21) Appl. No.: 18/004,331

(22) PCT Filed: Jul. 12, 2021
(86) PCT No.: PCT/IB2021/056249

§ 371 Date: Jan. 5, 2023

Related U.S. Application Data
(60) Provisional application No. 63/051,559, filed on Jul. 14, 2020.

(51) Int. Cl. C08F 210/16

(52) U.S. Cl. CPC C08F 210/16

(57) ABSTRACT

A medium pressure solution phase polymerization process is provided in which the amount of long chain branching present in an ethylene/1-octene copolymer is controlled with a bridged hafnocene polymerization catalyst in the presence of different polymerization process conditions.

### TECHNICAL FIELD

A bridged hafnocene polymerization catalyst is used in a solution phase polymerization process to polymerize ethylene with 1-octene at medium pressure. The amount of long chain branching formed in the ethylene/1-octene copolymer is manipulated by changing the conditions in the solution phase polymerization reactor.

### BACKGROUND ART

The use of single site catalysts in the polymerization of ethylene with alpha-olefins allows for control over polymer features such as molecular weight and the degree and placement of short chain branching. Choice of single site catalyst structure and polymerization reaction conditions are also known to have an impact on whether significant amounts of so-called long chain branches are formed, but with less predictability.

The amount of long chain branching in an ethylene/alpha-olefin copolymer is known by persons skilled in the art to affect the performance properties of the copolymer, especially processability and toughness properties. Accordingly, there remains a need for single site catalyzed polymerization processes which afford ethylene alpha copolymers with high degrees of control and predictability over the long chain branching content in response to polymerization conditions.

### SUMMARY OF INVENTION

The present disclosure provides a solution phase polymerization process in which the use of a hafnocene catalyst allows for the manipulation of the amount of long chain branching present in an ethylene/alpha-olefin copolymer in response to polymerization process conditions.

An embodiment of the disclosure, is a solution phase polymerization process for making an ethylene/1-octene copolymer, the process comprising:
polymerizing ethylene and 1-octene with a single site catalyst system in a continuous solution phase polymerization reactor at a temperature of at least 140° C. in the presence of hydrogen, and
altering the stress exponent of the ethylene/1-octene copolymer by changing one or more of the following conditions in the continuous solution phase polymerization reactor:
   i) the concentration of ethylene;
   ii) the percent conversion of ethylene into ethylene/1-octene copolymer;
   iii) the concentration of hydrogen;
   iv) the mass ratio of 1-octene:ethylene;
   v) the temperature;

wherein the single site catalyst system comprises:
   a) a metallocene catalyst having the formula: 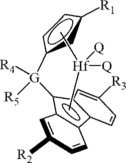
wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand; and
   b) a catalyst activator.

In an embodiment of the disclosure, the ethylene feed concentration to the continuous solution phase polymerization reactor is from 9 to 26 weight percent of ethylene in the feed solvent (i.e. the concentration of ethylene in the solvent fed to the reactor).

In an embodiment of the disclosure, the pressure in a continuous solution phase polymerization reactor is from 10.3 to 31 MPa.

In an embodiment of the disclosure, the residence time in the continuous solution phase polymerization reactor is from 0.5 to 5 minutes.

In an embodiment of the disclosure, an ethylene/1-octene copolymer has a melt index, I₂ of from 0.1 to 5.0 g/10 min.

In an embodiment of the disclosure, an ethylene/1-octene copolymer has a melt index, I₂ of less than 2.0 g/10 min.

In an embodiment of the disclosure, an ethylene/1-octene copolymer has a melt index, I₂ of less than 1.0 g/10 min.

In an embodiment of the disclosure, an ethylene/1-octene copolymer has a density of from 0.865 to 0.930 g/cm³.

In an embodiment of the disclosure, an ethylene/1-octene copolymer has a density of from 0.895 to 0.930 g/cm³.

In an embodiment of the disclosure, a catalyst activator system comprises: i) an ionic activator; ii) an alkylaluminoxane; and iii) a hindered phenol compound.

In an embodiment of the disclosure a metallocene catalyst has the formula:

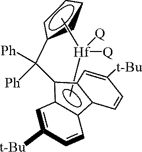

wherein Q is independently an activatable leaving group ligand.

In an embodiment of the disclosure, a solution phase polymerization process for making an ethylene/1-octene copolymer, comprises polymerizing ethylene and 1-octene with a single site catalyst system in a continuous solution phase polymerization reactor at a temperature of at least 160° C.

### BRIEF DESCRIPTION OF THE DRAWINGS

FIG. 1 shows how the stress exponent (S.Ex.) of an ethylene/1-octene copolymer changes as the concentration of ethylene (in weight percent) in a solution phase polymerization reactor is deliberately changed.

FIG. 2 shows how the stress exponent (S.Ex.) of an ethylene/1-octene copolymer changes as the percent conversion of ethylene into an ethylene/1-octene copolymer in a solution phase polymerization reactor is deliberately changed.

FIG. 3 shows a plot of the phase angle, δ (in °) vs the complex modulus, G* (in Pa) for ethylene/1-octene copolymers made at different conversions of ethylene (in percent) into an ethylene/1-octene copolymer in a solution phase polymerization reactor.

FIG. 4 shows how the stress exponent (S.Ex.) of an ethylene/1-octene copolymer changes as the amount of hydrogen (in ppm) in a solution phase polymerization reactor is deliberately changed.

FIG. 5 shows how the stress exponent (S.Ex.) of an ethylene/1-octene copolymer changes as the mass ratio of 1-octene:ethylene (in grams:grams) fed to a solution phase polymerization reactor is deliberately changed.

FIG. 6 shows how the stress exponent (S.Ex.) of an ethylene/1-octene copolymer changes as the temperature (in °C) in a solution phase polymerization reactor is deliberately changed.

### DESCRIPTION OF EMBODIMENTS

In the solution phase polymerization process of the present disclosure, ethylene is copolymerized with one or more than one alpha-olefin using a single site catalyst system capable of producing long chain branches.

In an embodiment of the present disclosure, the amount of long chain branching present in an ethylene/alpha-olefin copolymer is indicated by measuring the Long Chain Branching Factor (the “LCBF”) of the ethylene/alpha-olefin copolymer.

In an embodiment of the disclosure, the LCBF of an ethylene/alpha-olefin copolymer is altered by changing one or more of the following conditions in a solution phase polymerization reactor:
i) the concentration of ethylene;
ii) the percent conversion of ethylene into ethylene/1-octene copolymer;
iii) the concentration of hydrogen;
iv) the mass ratio of 1-octene:ethylene;
v) the temperature.

In an embodiment of the present disclosure, the amount of long chain branching present in an ethylene/alpha-olefin copolymer is indicated by measuring the “stress exponent” of the ethylene/alpha-olefin copolymer.

In an embodiment of the disclosure, the stress exponent of an ethylene/alpha-olefin copolymer is altered by changing one or more of the following conditions in a solution phase polymerization reactor:
i) the concentration of ethylene;
ii) the percent conversion of ethylene into ethylene/1-octene copolymer;
iii) the concentration of hydrogen;
iv) the mass ratio of 1-octene:ethylene;
v) the temperature.

### Definitions

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene copolymer” is made using ethylene and one or more other types of polymerizable monomer (e.g. an alpha-olefin).

Common polyethylenes include high density polyethylene (HDPE), medium density polyethylene (MDPE), linear low density polyethylene (LLDPE), very low density polyethylene (VLDPE), ultralow density polyethylene (ULDPE), plastomers and elastomers. The term polyethylene also includes polyethylene terpolymers which may include two or more comonomers (e.g. alpha-olefins) in addition to ethylene. The term polyethylene also includes combinations of, or blends of, the polyethylenes described above.

The term “heterogeneously branched polyethylene” refers to a subset of polymers in the ethylene polymer group that are produced using a heterogeneous catalyst system; non-limiting examples of which include Ziegler-Natta or chromium catalysts, both of which are well known in the art.

The term “homogeneously branched polyethylene” refers to a subset of polymers in the ethylene polymer group that are produced using single-site catalysts; non-limiting examples of which include metallocene catalysts, phosphinimine catalysts, and constrained geometry catalysts all of which are well known in the art.

Typically, homogeneously branched polyethylenes have narrow molecular weight distributions, for example gel permeation chromatography (GPC) M_{w}/Mₙ values of less than about 2.8, or less than about 2.3, although exceptions may arise; M_{w} and Mₙ refer to weight and number average molecular weights, respectively. In contrast, the M_{w}/Mₙ of heterogeneously branched ethylene polymers are typically greater than the M_{w}/Mₙ of homogeneous polyethylene. In general, homogeneously branched ethylene polymers also have a narrow composition distribution, i.e. each macromolecule within the molecular weight distribution has a similar comonomer content. Frequently, the composition distribution breadth index “CDBI” is used to quantify how the comonomer is distributed within an ethylene polymer, as well as to differentiate ethylene polymers produced with different catalysts or processes. The “CDBI₅₀” is defined as the percent of ethylene polymer whose composition is within 50 weight percent (wt.%) of the median comonomer composition; this definition is consistent with that described in WO 93/03093 assigned to Exxon Chemical Patents Inc. The CDBI₅₀ of an ethylene copolymer can be calculated from TREF curves (Temperature Rising Elution Fractionation); the TREF method is described in Wild, et al., J. Polym. Sci., Part B, Polym. Phys., Vol. 20 (3), pages 441-455. Typically, the CDBI₅₀ of homogeneously branched ethylene polymers are greater than about 70 wt.% or greater than about 75 wt.%. In contrast, the CDBI₅₀ of α-olefin containing heterogeneously branched ethylene polymers are generally lower than the CDBI₅₀ of homogeneous ethylene polymers. For example, the CDBI₅₀ of a heterogeneously branched ethylene polymer may be less than about 75 wt.%, or less than about 70 wt.%.

It is well known to those skilled in the art, that homogeneously branched ethylene polymers are frequently further subdivided into “linear homogeneous ethylene polymers” and “substantially linear homogeneous ethylene polymers”. These two subgroups differ in the amount of long chain branching: more specifically, linear homogeneous ethylene polymers have less than about 0.01 long chain branches per 1000 carbon atoms; while substantially linear homogeneous ethylene polymers have greater than about 0.01 to about 3.0 long chain branches per 1000 carbon atoms. A long chain branch is macromolecular in nature, i.e. similar in length to the macromolecule that the long chain branch is attached to. Hereafter, in this disclosure, the term “homogeneously branched polyethylene” or “homogeneously branched ethylene polymer” refers to both linear homogeneous ethylene polymers and substantially linear homogeneous ethylene polymers.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl. An “alkylaryl” is an aryl group having one or more alkyl groups pendant there from; non-limiting examples include tolyl, xylyl, mesityl and cumyl.

An “alkoxy” group is an oxy group having an alkyl group pendant there from and includes for example a methoxy group, an ethoxy group, an iso-propoxy group and the like.

An “aryloxy” or “aryl oxide” group is an oxy group having an aryl group pendant there from and includes for example a phenoxy group and the like.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In one embodiment, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (non-hydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non-limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals and combinations thereof.

In the present disclosure, the term “continuous” means that the solution phase polymerization process was conducted using a continuous solution polymerization reactor, and that the process is continuous in all feed streams (e.g. solvent, monomers, polymerization catalyst) as well as in the removal of product.

In the present disclosure, the residence time is defined as the average time the catalyst, solvent, monomer and comonomer spend in a polymerization reactor. The average residence time is determined by taking the reactor volume and dividing by the total volumetric feed per unit of time (derivable from the total solution rate, the TSR, which is the total flow in kg/hour) to the reactor. In practice, the actual residence time is a distribution centered around the average residence time. The average reactor residence time may vary widely depending on process flow rates, whereas, the distribution of residence times can change with reactor mixing and reactor design.

### The Polymerization Catalyst

In an embodiment of the present disclosure, a single site catalyst system is used to polymerize ethylene with an alpha-olefin in a solution phase polymerization process.

In an embodiment of the present disclosure, a single site catalyst system is used to polymerize ethylene with 1-octene in a solution phase polymerization process.

In an embodiment of the present disclosure, the single site catalysts system comprises i) a metallocene catalyst, having hafnium, Hf, as the active metal center and ii) a catalyst activator.

In an embodiment of the disclosure, the metallocene catalyst has the formula:

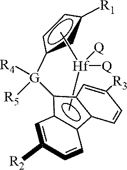

wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R₄ and R₅ are a substituted phenyl group, wherein the phenyl group is substituted at the para position with a trimethylsilyl group. In an embodiment, R₄ and R₅ are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment of the disclosure, the metallocene catalyst has the formula:

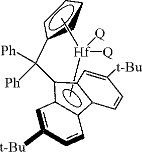

wherein Q is independently an activatable leaving group ligand.

In the current disclosure, the term “activatable leaving group”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group). Without wishing to be bound by any single theory, protonolysis or abstraction reactions generate an active “cationic” metal center which can polymerize olefins.

In embodiments of the present disclosure, the activatable leaving group ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. In embodiments of the disclosure, two Q ligands may also be joined to one another and form for example, a substituted or unsubstituted diene ligand (e.g. 1,3-butadiene); or a delocalized heteroatom containing group such as an acetate or acetamidinate group.

In an embodiment of the disclosure, each Q is independently selected from the group consisting of a halide atom, a C₁₋₄ alkyl radical and a benzyl radical.

In an embodiment, suitable activatable ligands, Q are monoanionic such as a halide (e.g. chloride) or a hydrocarbyl (e.g. methyl, benzyl).

In an embodiment, each activatable ligand, Q is a methyl group.

In an embodiment, each activatable ligand, Q is a benzyl group.

In an embodiment, each activatable ligand, Q is a chloride group.

In addition to the single site catalyst molecule per se, an active single site catalyst system typically further comprises a catalyst activator.

In an embodiment of the disclosure, a catalyst activator comprises an alkylaluminoxane and/or an ionic activator.

In an embodiment of the present disclosure, a catalyst activator may also optionally include a hindered phenol compound.

In an embodiment of the disclosure, a catalyst activator comprises an alkylaluminum, an ionic activator and a hindered phenol compound.

Although the exact structure of an alkylaluminoxane is uncertain, subject matter experts generally agree that it is an oligomeric species that contain repeating units of the general formula:

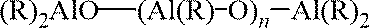

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from 10 to 40.

In an embodiment of the disclosure, the alkylaluminoxane is modified methylaluminoxane (MMAO).

It is well known in the art, that the alkylaluminoxane can serve dual roles as both an alkylator and an activator. Hence, an alkylaluminoxane catalyst activator is often used in combination with activatable ligands such as halogens.

In general, ionic activators are comprised of a cation and a bulky anion; wherein the latter is substantially non-coordinating. Non-limiting examples of ionic activators are boron ionic activators that are four, coordinate with four ligands bonded to the boron atom. Non-limiting examples of boron ionic activators include the following formulas shown below:

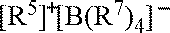

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula -Si(R⁹)₃, where each R⁹ is independently selected from hydrogen atoms and C₁₋₄ alkyl radicals, and

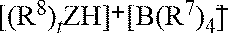

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5 -trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

In an embodiment of the disclosure, the catalyst activator comprises an ionic activator selected from the group consisting of N,N-dimethylaniliniumtetrakispentafluorophenyl borate (“[Me₂NHPh][B(C₆F₅)₄]”); triphenylmethylium tetrakispentafluorophenyl borate (“[Ph₃C][B(C₆F₅)₄]”, also known as “trityl borate”); and trispentafluorophenyl boron.

In an embodiment of the disclosure, the catalyst activator comprises triphenylmethylium tetrakispentafluorophenyl borate, “trityl borate”.

In embodiments of the disclosure, the catalyst activator comprises a hindered phenol compound selected from the group consisting of butylated phenolic antioxidants, butylated hydroxytoluene, 2,6-di-tertiarybutyl-4-ethyl phenol (BHEB), 4,4′-methylenebis (2,6-di-tertiary-butylphenol), 1,3, 5-trimethyl-2,4,6-tris (3,5-di-tert-butyl-4-hydroxybenzyl) benzene and octadecyl-3-(3′,5′-di-tert-butyl-4′-hydroxyphenyl) propionate.

In an embodiment of the disclosure, the catalyst activator comprises the hindered phenol compound, 2,6-di-tertiarybutyl-4-ethyl phenol (BHEB).

Optionally, in embodiment of the disclosure, mixtures of alkylaluminoxanes and ionic activators can be used as catalyst activators, optionally together with a hindered phenol compound.

To produce an active single site catalyst system the quantity and mole ratios of the above components: the metallocene catalyst (i.e. the single site catalyst molecule), the alkylaluminoxane, the ionic activator, and the optional hindered phenol are optimized.

In embodiments of the disclosure, the ionic activator compounds may be used in amounts which provide a molar ratio of hafnium, Hf (of the single site catalyst molecule) to boron that will be from 1:1 to 1:10, or from 1:1 to 1:6, or from 1:1 to 1:2.

In an embodiments of the disclosure, the mole ratio of aluminum contained in the alkylaluminoxane to the hafnium, Hf (of the single site catalyst molecule) will be from 5:1 to 1000:1, including narrower ranges within this range.

In an embodiment of the disclosure, the mole ratio of aluminum contained in the alkylaluminoxane to the hindered phenol (e.g. BHEB) will be from 1:1 to 1:0.1, including narrower ranges withing this range.

### The Polymerization Process

In an embodiment of the present disclosure, a solution phase polymerization process is a continuous polymerization process.

Solution polymerization processes (including continuous processes) for the copolymerization of ethylene with one or more than one alpha-olefin are well known in the art (see for example U.S. Pat. Nos. 6,372,864 and 6,777,509). Solution phase polymerization processes are conducted in the presence of an inert hydrocarbon solvent, typically, a C₅₋₁₂ hydrocarbon which may be unsubstituted or substituted by C₁₋₄ alkyl group such as pentane, methyl pentane, hexane, heptane, octane, cyclohexane, methylcyclohexane and hydrogenated naphtha. An example of a suitable solvent which is commercially available is “Isopar E” (a C₈₋₁₂ aliphatic solvent, from Exxon Chemical Co.).

It is also well known on the art that reactor feed streams (solvent, monomers, α-olefin, hydrogen, catalyst formulation, etc.) should be essentially free of catalyst deactivating poisons; non-limiting examples of poisons include trace amounts of oxygenates such as water, fatty acids, alcohols, ketones and aldehydes. Such poisons are removed from reactor feed streams using standard purification practices; non-limiting examples include molecular sieve beds, alumina beds and oxygen removal catalysts for the purification of solvents, ethylene, etc..

The polymerization temperature in a conventional solution phase polymerization process is from about 80° C. to about 300° C. In an embodiment of the disclosure the polymerization temperature in a solution process is from about 120° C. to about 250° C.

In an embodiment of the disclosure, the solution phase polymerization process is carried out at a temperature of at least 130° C., or at least 140° C., or at least 150° C. In another embodiment of the disclosure, the solution phase polymerization process is carried out at a temperature of at least 160° C. In still another embodiment of the disclosure, the solution phase polymerization process is carried out at a temperature of at least 180° C.

In an embodiment of the disclosure, the pressure under which a solution phase process is carried out is a “medium pressure process”, meaning that the pressure in the reactor is less than about 6,000 psi (about 41,400 kiloPascals or kPa).

In embodiments of the disclosure, the polymerization pressure in a solution phase polymerization process is from about 10,000 to about 40,000 kPa, or from about 14,000 to about 22,000 kPa.

In an embodiment of the disclosure, the pressure under which a solution phase polymerization process is carried out (i.e. the pressure in the reactor) will be at least 10,300 kPa (10.3 MPa).

In an embodiment of the disclosure, the pressure under which a solution phase polymerization process is carried out (i.e. the pressure in the reactor) will be from 10,300 to 31,000 kPa (10.3 to 31 MPa).

Suitable monomers for copolymerization with ethylene include C₃₋₂₀ mono- and diolefins. Comonomers include C₃₋₁₂ alpha-olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g. 5-methylene-2-norbornene and 5-ethylidene-2-norbornene, bicyclo-(2,2,1)-hepta-2,5-diene).

The present disclosure may also be used to prepare co-and ter-polymers of ethylene, propylene and optionally one or more diene monomers. Generally, such polymers will contain about 50 to about 75 weight % ethylene, or from about 50 to 60 weight % ethylene and correspondingly from 50 to 25 weight % of propylene. A portion of the monomers, typically the propylene monomer, may be replaced by a conjugated diolefin. The diolefin may be present in amounts up to 10 weight % of the polymer although typically is present in amounts from about 3 to 5 weight %. The resulting polymer may have a composition comprising from 40 to 75 weight % of ethylene, from 50 to 15 weight % of propylene and up to 10 weight % of a diene monomer to provide 100 weight % of the polymer. Non-limiting examples of dienes are dicyclopentadiene, 1,4-hexadiene, 5-methylene-2-norbornene, 5-ethylidene-2-norbornene and 5-vinyl-2-norbornene, especially 5-ethylidene-2-norbornene and 1,4-hexadiene.

In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane, toluene) may be treated in a similar manner.

The feedstock may be heated or cooled prior to feeding to the reactor. However, in many instances it is desired to remove heat from the reactor so the feed stock may be at ambient temperature to help cool the reactor.

Generally, the catalyst components (the olefin polymerization catalyst molecule per se, an ionic activator, an alkylaluminoxane and optionally a hindered phenol) may be premixed in the solvent for the reaction or fed as separate streams to the reactor. In some instances, premixing it may be desirable to provide a reaction time for the catalyst components prior to entering the reaction. Such an “in line mixing” technique is described in a number of patents in the name of DuPont Canada Inc. (e.g., U.S. Pat. No. 5,589,555 issued Dec. 31, 1996).

The reactor system may comprise one or more reactors. It is well known to use two such reactors, in series, each of which may be operated so as to achieve different polymer molecular weight characteristics. The residence time in the reactor system will depend on the design and the capacity of the reactor and the flow rate of the solvent and monomer to the reactor. On leaving the reactor system the solvent is removed and the resulting polymer is recovered in a conventional manner.

In an embodiment, the process of this disclosure enables from 70 to 95% of the ethylene that is fed to a reactor to be converted into an ethylene/alpha-olefin copolymer (polymerized) in a residence time (also known as Hold Up Time) of from 0.5 to 5 minutes. For clarity, this rate of conversion must be achieved in at least one reactor, if two or more reactors are used. However, if a second or more reactor is employed, it is not required (in all embodiments) to achieve this rate of reaction in all reactors.

In an embodiment of the disclosure, the ethylene feed concentration to a continuous solution phase polymerization reactor is from 70 to 150 grams per liter of solvent.

In an embodiment of the disclosure, the ethylene concentration in a feed stream to a continuous solution phase polymerization reactor (i.e. the concentration of ethylene in the solvent fed to a reactor) is from 5 to 40 weight percent (wt.%). In another embodiment of the disclosure, the ethylene concentration in a feed stream to a continuous solution phase polymerization reactor (i.e. the concentration of ethylene in the solvent fed to a reactor) is from 5 to 35 wt.%. In yet another embodiment of the disclosure, the ethylene concentration in a feed stream to a continuous solution phase polymerization reactor (i.e. the concentration of ethylene in the solvent fed to a reactor) is from 5 to 30 wt.%. In still yet another embodiment of the disclosure, the ethylene concentration in a feed stream to a continuous solution phase polymerization reactor (i.e. the concentration of ethylene in the solvent fed to a reactor) is from 9 to 26 wt.%. In still yet another embodiment of the disclosure, the ethylene concentration in a feed stream to a continuous solution phase polymerization reactor (i.e. the concentration of ethylene in the solvent fed to a reactor) is from 9 to 16 wt.%.

In an embodiment of the disclosure, the pressure in a continuous solution phase polymerization reactor is from 10.3 to 31 MPa. In another embodiment of the disclosure, the pressure in a continuous solution phase polymerization reactor is from 10.5 to 21 MPa.

In an embodiment of the disclosure, the residence time in the continuous solution phase polymerization reactor is from 0.5 to 5 minutes. In an embodiment of the disclosure, the residence time in the continuous solution phase polymerization reactor is from 30 seconds to 360 seconds. In an embodiment of the disclosure, the residence time in the continuous solution phase polymerization reactor is from 30 seconds to 120 seconds.

### Ethylene/Alpha-Olefin Copolymer

The ethylene/alpha-olefin copolymer produced in the present disclosure will have varying amounts of long chain branching (LCB) present as further described below.

Long chain branching (LCB) is a well-known structural phenomenon in ethylene copolymers and well known to those of ordinary skill in the art. Traditionally, there are three methods for LCB analysis, namely, nuclear magnetic resonance spectroscopy (NMR), for example see J.C. Randall, J Macromol. Sci., Rev. Macromol. Chem. Phys. 1989, 29, 201; triple detection SEC equipped with a DRI, a viscometer and a low-angle laser light scattering detector, for example see W.W. Yau and D.R. Hill, Int. J. Polym. Anal. Charact. 1996; 2:151; and rheology, for example see W.W. Graessley, Acc. Chem. Res. 1977, 10, 332-339. In embodiments of this disclosure, a long chain branch is macromolecular in nature, i.e. long enough to be seen in an NMR spectra, triple detector SEC experiments or rheological experiments.

In an embodiment of the disclosure, the ethylene/alpha-olefin copolymer contains long chain branching characterized by the Long Chain Branching Factor, the “LCBF” disclosed herein.

In embodiments of the disclosure, the upper limit on the LCBF of the ethylene/alpha-olefin copolymer may be about 0.75, or about 0.5, in other cases about 0.4 and in still other cases about 0.3 (dimensionless). In embodiments of the disclosure, the lower limit on the LCBF of the ethylene/alpha-olefin copolymer may be about 0.001, in other cases about 0.0015, or in other cases about 0.002, or in other cases 0.01 (dimensionless), or in other cases 0.05 (dimensionless), or in other cases 0.075 (dimensionless).

In an embodiment of the disclosure, the ethylene/alpha-olefin copolymer has a dimensionless long chain branching factor, LCBF of ≥ 0.001.

In embodiments of the disclosure, the LCBF of the ethylene/alpha-olefin copolymer may be from 0.010 to 0.750, including narrower ranges within this range such as from 0.010 to 0.500, or from 0.010 to 0.400.

In embodiments of the disclosure, the ethylene/alpha-olefin copolymers which may be prepared in accordance with the present disclosure are LLDPE’s and may comprise not less than 60, or not less than 75 weight % of ethylene with the balance being one or more C₄₋₁₀ alpha-olefins, such as alpha-olefins selected from the group consisting of 1-butene, 1-hexene and 1-octene.

In embodiments of the disclosure, the alpha-olefin present in an ethylene copolymer, may be present in an amount from about 3 to 30 weight %, or from about 4 to 25 weight %, or from 1 to 20 weight %, or from 1 to 12 weight %.

In an embodiment of the disclosure, the ethylene/alpha-olefin copolymer is an ethylene/1-octene copolymer.

The ethylene copolymer prepared in accordance with the present disclosure may be a LLDPE having a density from about 0.910 to 0.935 g/cm³ or (linear) high density polyethylene (HDPE) having a density above 0.935 g/cm³. The present disclosure might also be useful to prepare an ethylene copolymer having a density below 0.910 g/cm³ - the so-called very low and ultra-low density polyethylenes (ULDPE).

In an embodiment, the ethylene/alpha-olefin copolymer prepared in accordance with the presently disclosed solution phase polymerization process will have a reasonably high molecular weight even when prepared in the presence of hydrogen. That is, the ethylene/alpha-olefin prepared will have a weight average molecular weight, Mw which will be greater than about 20,000 g/mol or greater than about 30,000 g/mol, or greater than about 40,000 g/mol, even when prepared in the presence of hydrogen.

In an embodiment, the ethylene/alpha-olefin copolymer prepared in accordance with the presently disclosed solution phase polymerization process will have a melt index, I₂ of from 0.1 to 10 g/10 min. In another embodiment, the ethylene/alpha-olefin copolymer prepared in accordance with the presently disclosed solution phase polymerization process will have a melt index, I₂ of from 0.1 to 5.0 g/10 min.

In an embodiment, the ethylene/alpha-olefin copolymer prepared in accordance with the presently disclosed solution phase polymerization process will have a melt index, I₂ of less than 2.0 g/10 min.

In an embodiment, the ethylene/alpha-olefin copolymer prepared in accordance with the presently disclosed solution phase polymerization process will have a melt index, I₂ of less than 1.0 g/10 min.

In an embodiment, the ethylene/alpha-olefin copolymer prepared in accordance with the presently disclosed solution phase polymerization process will have a density of from a density of from 0.865 to 0.930 g/cm³. In another embodiment, the ethylene/alpha-olefin copolymer prepared in accordance with the presently disclosed solution phase polymerization process will have a density of from a density of from 0.895 to 0.930 g/cm³.

In an embodiment, the ethylene/1-octene copolymer prepared in accordance with the presently disclosed solution phase polymerization process will have a melt index, I₂ of from 0.1 to 10 g/10 min. In another embodiment, the ethylene/1-octene copolymer prepared in accordance with the presently disclosed solution phase polymerization process will have a melt index, I₂ of from 0.1 to 5.0 g/10 min.

In an embodiment, the ethylene/1-octene copolymer prepared in accordance with the presently disclosed solution phase polymerization process will have a melt index, I₂ of less than 2.0 g/10 min.

In an embodiment, the ethylene/1-octene copolymer prepared in accordance with the presently disclosed solution phase polymerization process will have a melt index, I₂ of less than 1.0 g/10 min.

In an embodiment, the ethylene/1-octene copolymer prepared in accordance with the presently disclosed solution phase polymerization process will have a density of from a density of from 0.865 to 0.930 g/cm³. In another embodiment, the ethylene/1-octene copolymer prepared in accordance with the presently disclosed solution phase polymerization process will have a density of from a density of from 0.895 to 0.930 g/cm³.

### The Stress Exponent

Several indices are known to correlate with the amount of long chain branching present in an ethylene/alpha-olefin copolymer, one of which is the so called “stress exponent”. Without wishing to be bound by any particular theory, the higher the stress exponent measured for an given ethylene copolymer, the greater the amount of long chain branching believed to be present; conversely, the lower the stress exponent measured for an given ethylene copolymer, the lesser the amount of long chain branching believed to be present. The stress exponent, “S.Ex.” is defined as: log(I₆/I₂)/log(6480/2160) wherein I₆ and I₂ are the melt flow rates measured at 190° C. using 6.48 kg and 2.16 kg loads, respectively.

In the present disclosure, the stress exponent of an ethylene/1-octene copolymer made with the polymerization catalyst defined as above, in a solution polymerization process as defined above, is altered by changing one or more than one of the following conditions in a solution phase polymerization reactor:
i) the concentration of ethylene;
ii) the percent conversion of ethylene into ethylene/1-octene copolymer;
iii) the concentration of hydrogen;
iv) the mass ratio of 1-octene:ethylene;
v) the temperature.

In an embodiment of the disclosure, changing the concentration of ethylene in a solution phase polymerization reactor changes the stress exponent of an ethylene copolymer (e.g. an ethylene/1-octene copolymer) made with the polymerization catalyst defined above.

In embodiments of the disclosure, changing the concentration of ethylene in a solution phase polymerization reactor by at least 0.10 wt.%, or by at least 0.25 wt.%, or by at least 0.50 wt.%, or by at least 1.0 wt.%, alters the stress exponent of an ethylene copolymer (e.g. an ethylene/1-octene copolymer) made with the polymerization catalyst defined above.

In embodiments of the disclosure, increasing the concentration of ethylene in a solution phase polymerization reactor by at least 0.10 wt.%, or by at least 0.25 wt.%, or by at least 0.50 wt.%, or by at least 1.0 wt.%, increases the stress exponent of an ethylene copolymer (e.g. an ethylene/1-octene copolymer) made with the polymerization catalyst defined above.

In embodiments of the disclosure, decreasing the concentration of ethylene in a solution phase polymerization reactor by at least 0.10 wt.%, or by at least 0.25 wt.%, or by at least 0.50 wt.%, or by at least 1.0 wt.%, decreases the stress exponent of an ethylene copolymer (e.g. an ethylene/1-octene copolymer) made with the polymerization catalyst defined above.

In embodiments of the disclosure, changing the concentration of ethylene in a solution phase polymerization reactor by at least 0.50 wt.%, alters the stress exponent of an ethylene copolymer (e.g. an ethylene/1-octene copolymer) made with the polymerization catalyst defined above by at least 1.0%, or at least 2.0%, or at least 3.0%.

In embodiments of the disclosure, increasing the concentration of ethylene in a solution phase polymerization reactor by at least 0.50 wt.%, increases the stress exponent of an ethylene copolymer (e.g. an ethylene/1-octene copolymer) made with the polymerization catalyst defined above by at least 1.0%, or at least 2.0%, or at least 3.0%.

In embodiments of the disclosure, decreasing the concentration of ethylene in a solution phase polymerization reactor by at least 0.50 wt.%, decreases the stress exponent of an ethylene copolymer (e.g. an ethylene/1-octene copolymer) made with the polymerization catalyst defined above by at least 1.0%, or at least 2.0%, or at least 3.0%.

In an embodiment of the disclosure, changing the percent conversion of ethylene into ethylene copolymer (e.g. an ethylene/1-octene copolymer) in a solution phase polymerization reactor alters the stress exponent of the ethylene copolymer made with the polymerization catalyst defined above.

In embodiments of the disclosure, changing the percent conversion of ethylene into ethylene copolymer (e.g. an ethylene/1-octene copolymer) in a solution phase polymerization reactor by at least 1%, or at least 3%, or at 5%, or at least 10%, alters the stress exponent of the ethylene copolymer made with the polymerization catalyst defined above.

In embodiments of the disclosure, decreasing the percent conversion of ethylene into ethylene copolymer (e.g. an ethylene/1-octene copolymer) in a solution phase polymerization reactor by at least 1%, or at least 3%, or at 5%, or at least 10%, increases the stress exponent of the ethylene copolymer made with the polymerization catalyst defined above.

In embodiments of the disclosure, increasing the percent conversion of ethylene into ethylene copolymer (e.g. an ethylene/1-octene copolymer) in a solution phase polymerization reactor by at least 1%, or at least 3%, or at 5%, or at least 10%, decreases the stress exponent of the ethylene copolymer made with the polymerization catalyst defined above.

In embodiments of the disclosure, changing the percent conversion of ethylene into ethylene copolymer (e.g. an ethylene/1-octene copolymer) in a solution phase polymerization reactor by at least 5%, alters the stress exponent of the ethylene copolymer made with the polymerization catalyst defined above by at least 1.0%, or at least 2.0%, or at least 3.0%.

In embodiments of the disclosure, decreasing the percent conversion of ethylene into ethylene copolymer (e.g. an ethylene/1-octene copolymer) in a solution phase polymerization reactor by at least 5%, increases the stress exponent of the ethylene copolymer made with the polymerization catalyst defined above by at least 1.0%, or at least 2.0%, or at least 3.0%.

In embodiments of the disclosure, increasing the percent conversion of ethylene into ethylene copolymer (e.g. an ethylene/1-octene copolymer) in a solution phase polymerization reactor by at least 5%, decreases the stress exponent of the ethylene copolymer made with the polymerization catalyst defined above by at least 1.0%, or at least 2.0%, or at least 3.0%.

In an embodiment of the disclosure, changing the temperature in a solution phase polymerization reactor changes the stress exponent of an ethylene copolymer (e.g. an ethylene/1-octene copolymer) made with the polymerization catalyst defined above.

In embodiments of the disclosure, changing the temperature in a solution phase polymerization reactor by at least 1° C., or by at least 3° C., or by at least 5° C., or by at least 10° C., alters the stress exponent of an ethylene copolymer (e.g. an ethylene/1-octene copolymer) made with the polymerization catalyst defined above.

In embodiments of the disclosure, increasing the temperature in a solution phase polymerization reactor by at least 1° C., or by at least 3° C., or by at least 5° C., or by at least 10° C., decreases the stress exponent of an ethylene copolymer (e.g. an ethylene/1-octene copolymer) made with the polymerization catalyst defined above.

In embodiments of the disclosure, decreasing the temperature in a solution phase polymerization reactor by at least 1° C., or by at least 3° C., or by at least 5° C., or by at least 10° C., increases the stress exponent of an ethylene copolymer (e.g. an ethylene/1-octene copolymer) made with the polymerization catalyst defined above.

In an embodiment of the disclosure, changing the temperature in a solution phase polymerization reactor by at least 5° C., alters the stress exponent of an ethylene copolymer (e.g. an ethylene/1-octene copolymer) made with the polymerization catalyst defined above by at least 1.0%.

In an embodiment of the disclosure, increasing the temperature in a solution phase polymerization reactor by at least 5° C., decreases the stress exponent of an ethylene copolymer (e.g. an ethylene/1-octene copolymer) made with the polymerization catalyst defined above by at least 1.0%.

In an embodiment of the disclosure, decreasing the temperature in a solution phase polymerization reactor by at least 5° C., increases the stress exponent of an ethylene copolymer (e.g. an ethylene/1-octene copolymer) made with the polymerization catalyst defined above by at least 1.0%.

In an embodiment of the disclosure, changing the concentration of hydrogen in a solution phase polymerization reactor changes the stress exponent of an ethylene copolymer (e.g. an ethylene/1-octene copolymer) made with the polymerization catalyst defined above.

In embodiments of the disclosure, changing the concentration of hydrogen in a solution phase polymerization reactor by at least 1 ppm, or by at least 2 ppm, or by at least 3 ppm, or by at least 5 ppm, alters the stress exponent of an ethylene copolymer (e.g. an ethylene/1-octene copolymer) made with the polymerization catalyst defined above.

In embodiments of the disclosure, increasing the concentration of hydrogen in a solution phase polymerization reactor by at least 1 ppm, or by at least 2 ppm, or by at least 3 ppm, or by at least 5 ppm, decreases the stress exponent of an ethylene copolymer (e.g. an ethylene/1-octene copolymer) made with the polymerization catalyst defined above.

In embodiments of the disclosure, decreasing the concentration of hydrogen in a solution phase polymerization reactor by at least 1 ppm, or by at least 2 ppm, or by at least 3 ppm, or by at least 5 ppm, increases the stress exponent of an ethylene copolymer (e.g. an ethylene/1-octene copolymer) made with the polymerization catalyst defined above.

In embodiments of the disclosure, changing the concentration of hydrogen in a solution phase polymerization reactor by at least 3 ppm, alters the stress exponent of an ethylene copolymer (e.g. an ethylene/1-octene copolymer) made with the polymerization catalyst defined above by at least 1.0%, or at least 2.0%, or at least 3.0%.

In embodiments of the disclosure, increasing the concentration of hydrogen in a solution phase polymerization reactor by at least 3 ppm, decreases the stress exponent of an ethylene copolymer (e.g. an ethylene/1-octene copolymer) made with the polymerization catalyst defined above by at least 1.0%, or at least 2.0%, or at least 3.0%.

In embodiments of the disclosure, decreasing the concentration of hydrogen in a solution phase polymerization reactor by at least 3 ppm, increases the stress exponent of an ethylene copolymer (e.g. an ethylene/1-octene copolymer) made with the polymerization catalyst defined above by at least 1.0%, or at least 2.0%, or at least 3.0%.

In an embodiment of the disclosure, changing the mass ratio of 1-octene:ethylene in a solution phase polymerization reactor (or fed to said reactor) changes the stress exponent of an ethylene/1-octene copolymer made with the polymerization catalyst defined above.

In embodiments of the disclosure, changing the mass ratio of 1-octene:ethylene in a solution phase polymerization reactor (or fed to said reactor) by at least 25%, or by at least 50%, or by at least 75%, or by at least 100%, alters the stress exponent of an ethylene/1-octene copolymer made with the polymerization catalyst defined above.

In embodiments of the disclosure, increasing the mass ratio of 1-octene:ethylene in a solution phase polymerization reactor (or fed to said reactor) by at least 25%, or at least 50%, or by at least 75%, or by at least 100%, decreases the stress exponent of an ethylene/1-octene copolymer made with the polymerization catalyst defined above.

In embodiments of the disclosure, decreasing the mass ratio of 1-octene:ethylene in a solution phase polymerization reactor (or fed to said reactor) by at least 25%, or at least 50%, or by at least 75%, or by at least 100%, increases the stress exponent of an ethylene/1-octene copolymer made with the polymerization catalyst defined above.

In embodiments of the disclosure, changing the mass ratio of 1-octene:ethylene in a solution phase polymerization reactor (or fed to said reactor) by at least 100%, alters the stress exponent of an ethylene/1-octene copolymer made with the polymerization catalyst defined above by at least 1.0%, or at least 2.0%, or at least 3.0%.

In embodiments of the disclosure, increasing the mass ratio of 1-octene:ethylene in a solution phase polymerization reactor (or fed to said reactor) by at least 100%, decreases the stress exponent of an ethylene/1-octene copolymer made with the polymerization catalyst defined above by at least 1.0%, or at least 2.0%, or at least 3.0%.

In embodiments of the disclosure, decreasing the mass ratio of 1-octene:ethylene in a solution phase polymerization reactor (or fed to said reactor) by at least 100%, increases the stress exponent of an ethylene/1-octene copolymer made with the polymerization catalyst defined above by at least 1.0%, or at least 2.0%, or at least 3.0%.

In addition to simply changing one or more of the above conditions in a single direction in a solution phase polymerization reactor (i.e. to increase or decrease one or more of the: i) the concentration of ethylene; ii) the percent conversion of ethylene into ethylene/1-octene copolymer; iii) the concentration of hydrogen; iv) the mass ratio of 1-octene:ethylene; and v) the temperature), in an embodiment of the disclosure, these variables can also be changed in a cyclic manner. That is, they can be swept through cycles in which they are increased and decreased to desired levels during the solution phase polymerization process. Hence, in such an embodiment, cycling one or more of: i) the concentration of ethylene; ii) the percent conversion of ethylene into ethylene/1-octene copolymer; iii) the concentration of hydrogen; iv) the mass ratio of 1-octene:ethylene; and v) the temperature in a solution phase polymerization reactor alters the stress exponent of an ethylene/1-octene copolymer made with the polymerization catalyst defined above.

Further non-limiting details of the disclosure are provided in the following examples. The examples are presented for the purposes of illustrating selected embodiments of this disclosure, it being understood that the examples presented do not limit the claims presented.

### EXAMPLES

### General Testing Procedures

Prior to testing, each polymer specimen was conditioned for at least 24 hours at 23 ±2° C. and 50 ±10% relative humidity and subsequent testing was conducted at 23 ±2° C. and 50 ±10% relative humidity. Herein, the term “ASTM conditions” refers to a laboratory that is maintained at 23 ±2° C. and 50 ±10% relative humidity; and specimens to be tested were conditioned for at least 24 hours in this laboratory prior to testing. ASTM refers to the American Society for Testing and Materials.

### Density

Ethylene copolymer composition densities were determined using ASTM D792-13 (Nov. 1, 2013).

### Melt Index

Ethylene copolymer composition melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent” or its acronym “S.Ex.”, is defined by the following relationship: S.Ex.= log (I₆/I₂)/log(6480/2160) wherein I₆ and I₂ are the melt flow rates measured at 190° C. using 6.48 kg and 2.16 kg loads, respectively.

### Gel Permeation Chromatography (GPC)

Mₙ, M_{w}, and M_{z} (g/mol) were determined by high temperature Gel Permeation Chromatography (GPC) with differential refractive index (DRI) detection using universal calibration (e.g. ASTM -D6474-99). GPC data was obtained using an instrument sold under the trade name “Waters 150c”, with 1,2,4-trichlorobenzene as the mobile phase at 140° C. The samples were prepared by dissolving the polymer in this solvent and were run without filtration. Molecular weights are expressed as polyethylene equivalents with a relative standard deviation of 2.9% for the number average molecular weight (“Mn”) and 5.0% for the weight average molecular weight (“Mw”). The molecular weight distribution (MWD) is the weight average molecular weight divided by the number average molecular weight, M_{w}/Mₙ. The z-average molecular weight distribution is M_{z}/Mₙ. Polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect the columns from oxidative degradation. The sample injection volume was 200 mL. The raw data were processed with CIRRUS® GPC software. The columns were calibrated with narrow distribution polystyrene standards. The polystyrene molecular weights were converted to polyethylene molecular weights using the Mark-Houwink equation, as described in the ASTM standard test method D6474.

### Triple Detection Size Exclusion Chromatography (3D-SEC)

Ethylene/alpha-olefin copolymer samples (polymer) solutions (1 to 3 mg/mL) were prepared by heating the polymer in 1,2,4-trichlorobenzene (TCB) and rotating on a wheel for 4 hours at 150° C. in an oven. An antioxidant (2,6-di-tert-butyl-4-methylphenol (BHT)) was added to the mixture in order to stabilize the polymer against oxidative degradation. The BHT concentration was 250 ppm. Sample solutions were chromatographed at 140° C. on a PL 220 high-temperature chromatography unit equipped with a differential refractive index (DRI) detector, a dual-angle light scattering detector (15 and 90 degree) and a differential viscometer. The SEC columns used were either four SHODEX columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 µL. The SEC raw data were processed with the CIRRUS GPC software, to produce absolute molar masses and intrinsic viscosity ([η]). The term “absolute” molar mass was used to distinguish 3D-SEC determined absolute molar masses from the molar masses determined by conventional SEC. The viscosity average molar mass (Mᵥ) determined by 3D-SEC was used in the calculations to determine the Long Chain Branching Factor (LCBF).

### Unsaturation

The quantity of unsaturated groups, i.e. double bonds, in an ethylene copolymer was determined according to ASTM D3124-98 (published March 2011) and ASTM D6248-98 (published July 2012). An ethylene copolymer was: a) first subjected to an overnight carbon disulfide extraction to remove additives that may interfere with the analysis; b) the sample (pellet, film or granular form) was pressed into a plaque of uniform thickness (0.5 mm), and; c) the plaque was analyzed by FTIR to quantify the amount of terminal (vinyl) and internal unsaturation (trans-vinylene), and; d) the sample plaque was brominated and reanalyzed by FTIR to quantify the amount of side chain unsaturation (vinylidene). The IR resonances of these groups appear at 908 cm⁻¹, 965 cm⁻¹ and 888 cm⁻¹, respectively. The procedure is based on Beer’s Law: A = abdc, where a is the extinction coefficient for the specific unsaturation being measured, b is the plaque thickness, d the plaque density and c the selected unsaturation. Experimentally, the weight and area of the plaque are measured rather than the density and the thickness.

### Comonomer Content: Fourier Transform Infrared (FTIR) Spectroscopy

The quantity of comonomer in an ethylene copolymer composition was determined by FTIR and reported as the Short Chain Branching (SCB) content having dimensions of CH₃#/1000C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### Differential Scanning Calorimetry (DSC)

Primary melting peak (°C), melting peak temperatures (°C), heat of fusion (J/g) and crystallinity (%) was determined using differential scanning calorimetry (DSC) as follows: the instrument was first calibrated with indium; after the calibration, a polymer specimen is equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

### Dynamic Mechanical Analysis (DMA)

Oscillatory shear measurements under small strain amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 µm and a diameter of 25 mm. In this experiment, a sinusoidal strain wave was applied and the stress response was analyzed in terms of linear viscoelastic functions. The values of storage modulus (G′), loss modulus (G″), phase angle (δ), complex modulus (G*) and complex viscosity (η*) were obtained as a function of frequency. The zero shear rate viscosity (η₀) based on the DMA frequency sweep results was predicted by Ellis model (see R.B. Bird et al. “Dynamics of Polymer Liquids. Volume 1: Fluid Mechanics” Wiley-Interscience Publications (1987) p.228) or Carreau-Yasuda model (see K. Yasuda (1979) PhD Thesis, IT Cambridge).

In this disclosure, the LCBF (Long Chain Branching Factor) was determined using the DMA determined η₀ (see U.S. Pat. No. 10,442,920).

The DRI, is the “Dow rheology index”, and is defined by the equation: DRI = [365000(τ₀/η₀)-1]/10; wherein τ₀ is the characteristic relaxation time of the polyethylene and η₀ is the zero shear viscosity of the material. The DRI is calculated by least squares fit of the rheological curve (dynamic complex viscosity versus applied frequency e.g. 0.01-100 rads/s) as described in U.S. Pat. No. 6,114,486 with the following generalized Cross equation, i.e. η(ω)=η₀/[1+(ωτ₀)ⁿ]; wherein n is the power law index of the material, η(ω) and ω are the measured complex viscosity and applied frequency data respectively. When determining the DRI, the zero shear viscosity, η₀ used was estimated with the Ellis model, rather than the Cross model.

The crossover frequency is the frequency at which storage modulus (G′) and loss modulus (G″) curves cross with each other, while G′@G″=500 Pa is the storage modulus at which the loss modulus (G″) is at 500 Pa.

### Long Chain Branching Factor (LCBF)

The LCBF (dimensionless) was determined for the ethylene copolymer composition using the method described in U.S. Pat. No. 10,442,920 which is incorporated herein by reference.

The long chain branching factor (the “LCBF”) calculation requires the polydispersity corrected Zero Shear Viscosity (ZSV_{c}) and the short chain branching (the “SCB”) corrected Intrinsic Viscosity (IV_{c}) as fully described in the following paragraphs.

The correction to the Zero Shear Viscosity, ZSV_{c}, having dimensions of poise, was performed as shown in equation Eq. (1):

$$Z S {V}_{c} = \frac{1.8389 \times {η}_{0}}{{2.4110}^{L n \left(P d\right)}} \qquad \text{Eq. (1)}$$

where η₀, the zero shear viscosity (poise), was measured by DMA as described above; Pd was the dimensionless polydispersity (M_{w}/Mₙ) as measured using conventional GPC as described above and 1.8389 and 2.4110 are dimensionless constants.

The correction to the Intrinsic Viscosity, IV_{c}, having dimensions of dL/g, was performed as shown in equation Eq. (3):

$$I {V}_{c} = \left[η\right] + \frac{A \times S C B \times {M}_{v}^{0.725}}{1000000} \qquad \text{Eq. (2)}$$

where the intrinsic viscosity [η] (dL/g) was measured using 3D-SEC described above; the SCB has dimensions of (CH₃#/1000C) and was determined using FTIR as described above; Mᵥ, the viscosity average molar mass (g/mole), was determined using 3D-SEC as described above, and A was a dimensionless constant that depends on the α-olefin in the ethylene/α-olefin interpolymer sample, i.e. A was 2.1626, 1.9772 or 1.1398 for 1-octene, 1-hexene and 1-butene α-olefins, respectively. In the case of an ethylene homopolymer no correction is required for the Mark-Houwink constant, i.e. SCB is zero.

Linear ethylene/α-olefin interpolymers (which do not contain LCB or contain undetectable levels of LCB) fall on the Reference Line defined by Eq. (3).

$$\text{Log} \left({\text{IV}}_{\text{c}}\right) = 0.2100 \times \text{Log} \left(Z S {V}_{c}\right) - 0.7879 \qquad \text{Eq. (3)}$$

The calculation of the LCBF was based on the Horizontal-Shift (Sₕ) and Vertical-Shift (Sᵥ) from the linear reference line, as defined by the following equations:

$${S}_{h} = L o g \left(Z S {V}_{c}\right) - 4.7619 \times L o g \left(I {V}_{c}\right) - 3.7519 \qquad \text{Eq. (4)}$$

$${S}_{v} = 0.2100 \times L o g \left(Z S {V}_{c}\right) - L o g \left(I {V}_{c}\right) - 0.7879 \qquad \text{Eq.(5).}$$

In Eq. and (5), it is required that ZSV_{c} and IV_{c} have dimensions of poise and dL/g, respectively. The Horizontal-Shift (Sₕ) was a shift in ZSV_{c} at constant Intrinsic Viscosity (IV_{c}), if one removes the Log function its physical meaning is apparent, i.e. a ratio of two Zero Shear Viscosities, the ZSV_{c} of the sample under test relative to the ZSV_{c} of a linear ethylene polymer having the same IV_{c}. The Horizontal-Shift (Sₕ) was dimensionless. The Vertical-Shift (Sᵥ) was a shift in IV_{c} at constant Zero Shear Viscosity (ZSV_{c}), if one removes the Log function its physical meaning is apparent, i.e. a ratio of two Intrinsic Viscosities, the IV_{c} of a linear ethylene polymer having the same ZSV_{c} relative to the IV_{c} of the sample under test. The Vertical-Shift (Sᵥ) was dimensionless.

The dimensionless Long Chain Branching Factor (LCBF) was defined by Eq. (6):

$$L C B F = \frac{{S}_{h} \times {S}_{v}}{2} \qquad \text{Eq. (6)}$$

In an embodiment of the disclosure, resins having LCB are characterized as having a LCBF ≥ 0.001 (dimensionless); in contrast, resins having no LCB (or undetectable LCB) are characterized by a LCBF of less than 0.001 (dimensionless).

### Polymerization

All the polymerization experiments described below were conducted using a continuous solution polymerization reactor. The “TSR” is the total solution rate in kg/hour. The TSR is the sum (kg) of all flows to the reactor (e.g. solvent, monomer, comonomer and catalyst components) per hour. All components were stored and manipulated under an atmosphere of purified nitrogen.

The following examples illustrate the continuous solution copolymerization of ethylene and 1-octene at medium pressure in a dual reactor system connected in parallel. The examples below used only the first reactor to produce a unimodal polyethylene (see Tables 1-5). The first and second reactors could be operated at a pressure of about 16,000 kPa (about 2.3×10³ psi). The first reactor had a volume of 12 liters and the second reactor had a volume of 24 liters. Both reactors were agitated to ensure good mixing of the reactor contents. The process was continuous in all feed streams (i.e. solvent, which was methyl pentane; monomers, metallocene catalyst molecule; and cocatalyst components) and in the removal of product. Monomer (i.e. ethylene) and comonomer (i.e. 1-octene) were purified prior to addition to the reactor using conventional feed preparation systems (such as contact with various absorption media to remove impurities such as water, oxygen and polar contaminants). The reactor feeds were pumped to the reactors at the ratios shown in Tables 1-5. Average residence times for the reactors are calculated by dividing average flow rates by reactor volume. The residence time in each reactor for each of the examples was less than 1.5 minute and the reactors were well mixed.

The following single site catalyst (SSC) components were used to prepare the polyethylene in a first reactor (R1) configured in parallel to a second reactor (R2): diphenylmethylene(cyclopentadienyl)(2,7-di-t-butylfluorenyl)hafnium dimethide [(2,7-tBu₂Flu)Ph₂C(Cp)HfMe₂]; methylaluminoxane (MMAO-07); trityl tetrakis(pentafluorophenyl)borate (trityl borate), and 2,6-di-tert-butyl-4-ethylphenol (BHEB). Methylaluminoxane (MMAO-07) and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl)borate just before entering the polymerization reactor (R1).

The internal reactor temperature was monitored by a thermocouple in the polymerization medium and can be controlled at the required set point to +/- 0.5° C. Downstream of the polymerization reactor, the pressure was reduced from the reaction pressure to atmospheric pressure. The solid polymer was then recovered as a slurry in the condensed solvent and was dried in vacuum oven before analysis.

The ethylene conversion was determined by a dedicated on-line gas chromatograph.

In a series of experiments, ethylene/1-octene copolymers were made using the above catalyst system in a continuous solution phase polymerization reactor, while changing one of the following process conditions in the polymerization reactor: i) the concentration of ethylene; ii) the percent conversion of ethylene into ethylene/1-octene copolymer; iii) the concentration of hydrogen; iii) the mass ratio of 1-octene:ethylene; or iv) the temperature.

### Example 1, Stress Exponent as a Function of Ethylene Concentration & Example 2, Stress Exponent as a Function of Ethylene Conversion

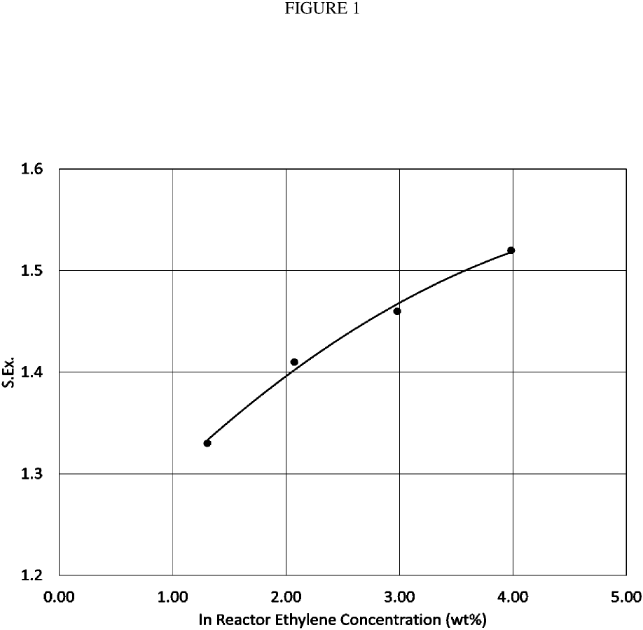

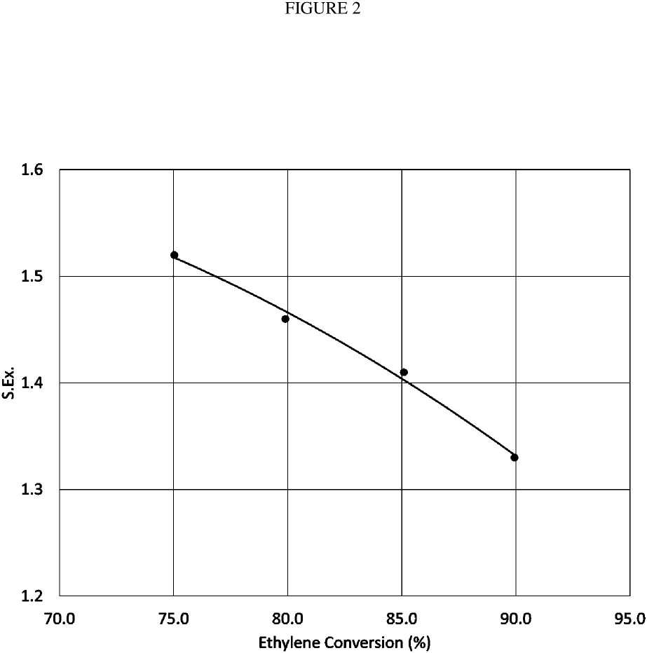

In these Examples (Examples 1A-1D & 2A-2D), ethylene/1-octene copolymers were made using the above catalyst system in a solution phase polymerization reactor, while changing the percentage conversion of ethylene into an ethylene/1-octene copolymer in the reactor while concomitantly changing of the concentration of ethylene in the reactor. The process data and some ethylene copolymer properties are shown in Table 1. The relationship between the concentration of ethylene in the reactor and the stress exponent of the ethylene copolymer is plotted in FIG. 1. The relationship between the conversion of ethylene and the stress exponent of the ethylene copolymer is plotted in FIG. 2.

TABLE 1

| Example No. | 1A/2A | 1B/2A | 1C/2C | 1D/2D |
|---|---|---|---|---|
| Reactor 1 (R1) | | | | |
| TSR (kg/hour) | 300 | 300 | 300 | 300 |
| In Reactor Ethylene Concentration (wt%) | 1.31 | 2.98 | 3.98 | 2.07 |
| 1-Octene/ethylene in Fresh Feed (g/g) | 0.25 | 0.25 | 0.25 | 0.25 |
| 1-Octene/ethylene Molar Ratio | 0.0621 | 0.0622 | 0.0623 | 0.0622 |
| Primary Feed Temperature (°C) | 30 | 30 | 30 | 30 |
| Mean Reactor Temperature (°C) | 185 | 185 | 185 | 185 |
| Ethylene Conversion (percent) | 89.9 | 79.9 | 75.0 | 85.1 |
| Hydrogen Feed (ppm) | 8 | 8 | 8 | 8 |
| Catalyst (ppm) to R1 | 0.565 | 0.319 | 0.253 | 0.395 |
| Al (ppm) to R1 | 0.919 | 0.931 | 0.932 | 0.931 |
| Al/Hf (mol/mol) | 43 | 77 | 98 | 63 |
| BHEB/Al (mol/mol) | 0.15 | 0.14 | 0.14 | 0.14 |
| B/Hf (mol/mol) | 1.22 | 1.22 | 1.21 | 1.22 |

| | | | | |
|---|---|---|---|---|
| Resin Properties | | | | |
| Density (g/cm³) | 0.9116 | 0.9124 | 0.9122 | 0.9117 |
| MI (melt index, I₂ in g/10 min) | 6.13 | 0.76 | 0.34 | 1.51 |
| Melt Flow Ratio (I₂₁/I₂) | 26.5 | 31.8 | 34.5 | 29.5 |
| Mw/Mn | 1.76 | 1.75 | 1.74 | 1.73 |
| Stress Exponent | 1.33 | 1.46 | 1.52 | 1.41 |
| LCBF | 0.0127 | 0.0717 | 0.1340 | 0.0428 |

As can be seen from the data in Table 1 and from FIG. 1, as the concentration of ethylene in the reactor is increased, the stress exponent of the ethylene/1-octene copolymer is increased, which indicates an increase in the amount of long chain branching present in the ethylene/1-octene copolymer.

As can be seen from the data in Table 1 and from FIG. 2, as the conversion of ethylene in the reactor is increased, the stress exponent of the ethylene/1-octene copolymer is decreased, which indicates a decrease in the amount of long chain branching present in the ethylene/1-octene copolymer.

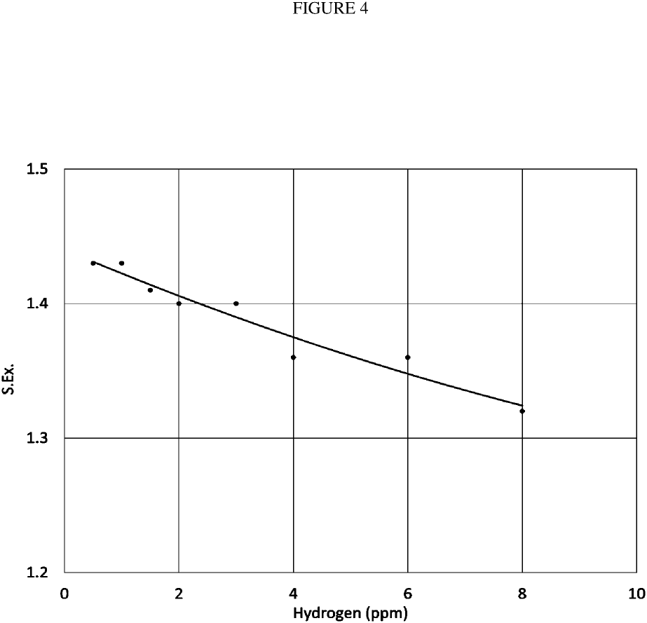

The hierarchical physical structure of ethylene polymers (e.g. an ethylene copolymer) can be characterized using melt rheology. A convenient method can be based on the small amplitude frequency sweep tests (e.g. as carried out by DMA). Such rheology results are expressed as the phase angle δ as a function of complex modulus G*, referred to as van Gurp-Palmen, “VGP” plots (as described in M. Van Gurp, J. Palmen, Rheol. Bull. (1998) 67(1): 5-8; and Dealy J, Plazek D. Rheol. Bull. (2009) 78(2): 16-31). For a typical ethylene polymer, the phase angle δ increases toward its upper bound of 90° with G* becoming sufficiently low. A typical VGP plot is shown in FIG. 4 of U.S. Pat. Appl. No. 2018/0298170 which is incorporated herein in its entirety. The VGP plots are a signature of resin architecture. The rise of δ toward 90° is monotonic for an ideally linear, monodisperse ethylene polymer. The δ (G*) for a branched ethylene polymer or a blend containing a branched ethylene polymer may show an inflection point that reflects the topology of the branched ethylene polymer (see S. Trinkle, P. Walter, C. Friedrich, Rheo. Acta (2002) 41: 103-113). Without wishing to be bound by theory, the deviation of the phase angle δ from the monotonic rise may indicate a deviation from the ideal linear ethylene polymer due to presence of long chain branching.

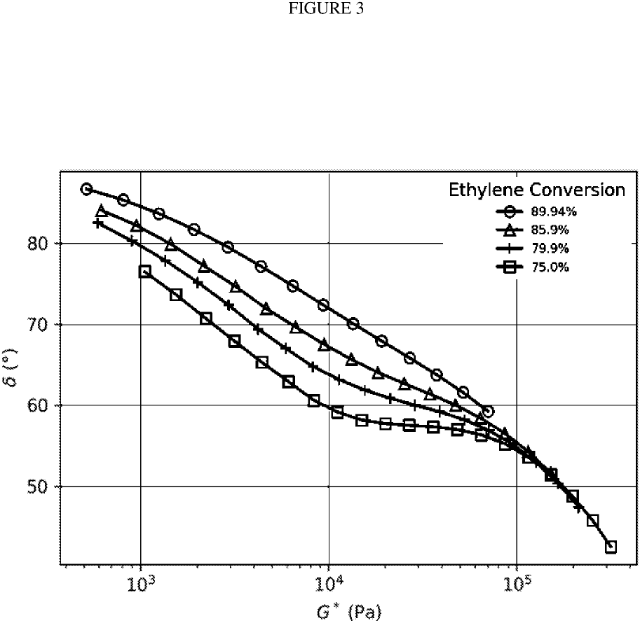

FIG. 3 shows the VGP plots for ethylene/1-octene copolymers made under different ethylene conversions. It is clear from the plots shown in FIG. 3 that as the ethylene conversion decreases, the shape of the curve changes and deepens toward having an inflection point at a phase angle, δ of below 60°. This indicates the presence of increasing amounts of long chain branching in the ethylene copolymer as the ethylene conversion decreases.

### Example 3: Stress Exponent as a Function of Hydrogen

In this Example (Examples 3A-3H), ethylene/1-octene copolymers were made using the above catalyst system in a solution phase polymerization reactor, while changing the amount of hydrogen in the reactor. The process data and some ethylene copolymer properties are shown in Table 2. The relationship between the amount of hydrogen in the reactor and the stress exponent of the ethylene copolymer is plotted in FIG. 4.

TABLE 2

| Example No. | 3A | 3B | 3C | 3D |
|---|---|---|---|---|
| Reactor 1 (R1) | | | | |
| TSR (kg/hour) | 300 | 300 | 300 | 300 |
| In Reactor Ethylene Concentration (wt%) | 1.31 | 1.29 | 1.31 | 1.30 |
| 1-Octene/ethylene in Fresh Feed (g/g) | 0.25 | 0.25 | 0.25 | 0.25 |
| 1-Octene/ethylene Molar Ratio | 0.0623 | 0.0625 | 0.0625 | 0.0626 |
| Primary Feed Temperature (°C) | 30 | 30 | 30 | 30 |
| Mean Reactor Temperature (°C) | 185 | 185 | 185 | 185 |
| Ethylene Conversion (%) | 90.1 | 90.1 | 89.9 | 90.0 |
| Hydrogen Feed (ppm) | 8.00 | 6.0 | 4.0 | 3.0 |
| Catalyst (ppm) to R1 | 0.691 | 0.650 | 0.875 | 0.864 |
| Al (ppm) to R1 | 1.127 | 0.9285 | 1.418 | 1.406 |
| Al/Hf (mol/mol) | 43 | 38 | 43 | 43 |
| BHEB/Al (mol/mol) | 0.15 | 0.15 | 0.15 | 0.15 |
| B/Hf (mol/mol) | 1.22 | 1.22 | 1.22 | 1.22 |
| Density (g/cm³) | 0.912 | 0.9116 | 0.9106 | 0.9105 |
| MI (melt index, I₂ in g/10 min) | 7.40 | 4.95 | 4.21 | 3.83 |
| Melt Flow Ratio (I₂₁/I₂) | 26.1 | 28.0 | 27.4 | 29.9 |
| Mw/Mn | 1.79 | | 1.82 | |
| Stress Exponent | 1.32 | 1.36 | 1.36 | 1.40 |
| LCBF | 0.0144 | | 0.0233 | |

TABLE 2 - CONTINUED

| Example No. | 3E | 3F | 3G | 3H |
|---|---|---|---|---|
| Reactor 1 (R1) | | | | |
| TSR (kg/hour) | 300 | 300 | 300 | 300 |
| In Reactor Ethylene Concentration (wt%) | 1.30 | 1.29 | 1.29 | 1.30 |
| 1-Octene/ethylene in Fresh Feed (g/g) | 0.25 | 0.25 | 0.25 | 0.25 |
| 1-Octene/ethylene Molar Ratio | 0.0626 | 0.0622 | 0.0619 | 0.0623 |
| Primary Feed Temperature (°C) | 30 | 30 | 30 | 30 |
| Mean Reactor Temperature (°C) | 185 | 185 | 185 | 185 |
| Ethylene Conversion (%) | 90.0 | 90.1 | 90.1 | 90.0 |
| Hydrogen Feed (ppm) | 2.0 | 1.5 | 1.0 | 0.5 |
| Catalyst (ppm) to R1 | 0.951 | 0.962 | 0.991 | 0.993 |
| Al (ppm) to R1 | 1.543 | 1.561 | 1.609 | 1.612 |
| Al/Hf (mol/mol) | 43 | 43 | 43 | 43 |
| BHEB/Al (mol/mol) | 0.15 | 0.15 | 0.15 | 0.15 |
| B/Hf (mol/mol) | 1.21 | 1.22 | 1.22 | 1.22 |
| Resin Properties | | | | |
| Density (g/cm³) | 0.9101 | 0.9102 | 0.9098 | 0.9094 |
| MI (melt index, I₂ in g/10 min) | 3.41 | 3.43 | 3.08 | 2.79 |
| Melt Flow Ratio (I₂₁/I₂) | 30.7 | 31.0 | 32.2 | 32.2 |
| Mw/Mn | | | 1.83 | 1.89 |
| Stress Exponent | 1.40 | 1.41 | 1.43 | 1.43 |
| LCBF | | | 0.0338 | 0.0397 |

As can be seen from the data in Table 2 and from FIG. 4, as the amount of hydrogen in the reactor is increased, the stress exponent of the ethylene/1-octene copolymer is decreased, which indicates a decrease in the amount of long chain branching present in the ethylene/1-octene copolymer.

### Example 4: Stress Exponent as a Function of the Mass Ratio of 1-Octene:Ethylene

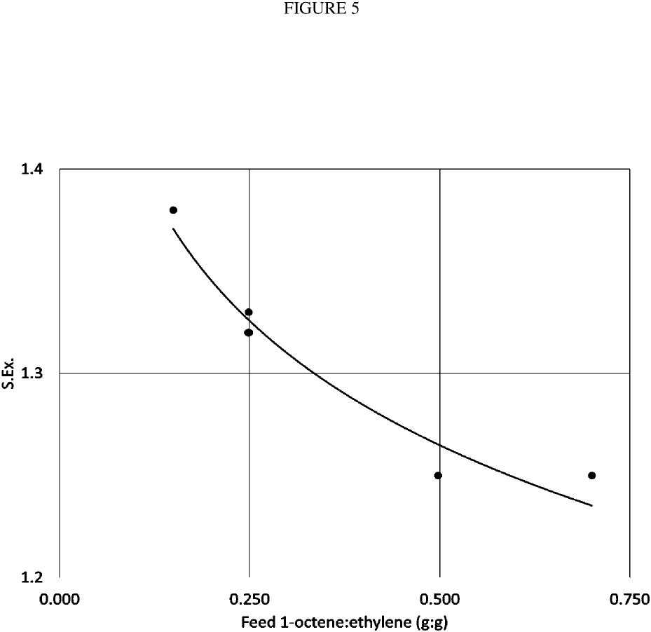

In this Example (Examples 4A-4F), ethylene/1-octene copolymers were made using the above catalyst system in a solution phase polymerization reactor, while changing the mass ratio of 1-octene:ethylene in the reactor. The process data and some ethylene copolymer properties are shown in Table 3. The relationship between the mass ratio of 1-octene:ethylene fed to the reactor and the stress exponent of the ethylene copolymer is plotted in FIG. 5.

TABLE 3

| Example No. | 4A | 4B | 4C | 4D | 4E | 4F |
|---|---|---|---|---|---|---|
| Reactor 1 (R1) | | | | | | |
| TSR (kg/hour) | 300 | 300 | 300 | 300 | 300 | 300 |
| In Reactor Ethylene Concentration (wt%) | 1.27 | 1.29 | 1.30 | 1.27 | 1.31 | 1.27 |
| 1-Octene/ethylene in Fresh Feed (g/g) | 0.15 | 0.25 | 0.25 | 0.50 | 0.25 | 0.70 |
| 1-Octene/ethylene Molar Ratio | 0.0374 | 0.0623 | 0.0619 | 0.1244 | 0.0621 | 0.1743 |
| Primary Feed Temperature (°C) | 30 | 30 | 30 | 30 | 30 | 30 |
| Mean Reactor Temperature (°C) | 185.34 | 185.20 | 185.01 | 184.99 | 185 | 185 |
| Ethylene Conversion (%) | 90.40 | 90.1 | 90.04 | 90 | 89.9 | 89.8 |
| Hydrogen Feed (ppm) | 8.00 | 7.99 | 7.99 | 7.99 | 8.00 | 8.00 |
| Catalyst (ppm) to R1 | 0.560 | 0.691 | 0.601 | 0.857 | 0.565 | 1.079 |
| Al (ppm) to R1 | 0.909 | 1.127 | 0.976 | 1.392 | 0.919 | 1.750 |
| Al/Hf (mol/mol) | 43 | 43 | 43 | 43 | 43 | 43 |
| BHEB/Al (mol/mol) | 0.15 | 0.15 | 0.15 | 0.15 | 0.15 | 0.15 |
| B/Hf (mol/mol) | 1.22 | 1.22 | 1.22 | 1.22 | 1.22 | 1.22 |
| Resin Properties | | | | | | |
| Density (g/cm³) | 0.9188 | 0.9120 | 0.9124 | 0.8974 | 0.9116 | 0.8867 |
| MI (melt index, I₂ in g/10 min) | 3.52 | 7.40 | 6.71 | 28.00 | 6.13 | 70.3 |
| Melt Flow Ratio (I₂₁/I₂) | 28.3 | 26.1 | 26.1 | 23.9 | 26.5 | 9.2 |
| Mw/Mn | 1.76 | 1.79 | 1.80 | 1.76 | 1.81 | |
| Stress Exponent | 1.38 | 1.32 | 1.32 | 1.25 | 1.33 | 1.25 |
| LCBF | 0.0287 | 0.0144 | 0.013 | 0.00 | 0.0127 | |

As can be seen from the data in Table 3 and from FIG. 5, as the mass ratio of 1-octene:ethylene in the reactor is increased, the stress exponent of the ethylene/1-octene copolymer is decreased, which indicates a decrease in the amount of long chain branching present in the ethylene/1-octene copolymer.

### Example 5: Stress Exponent as a Function of Temperature

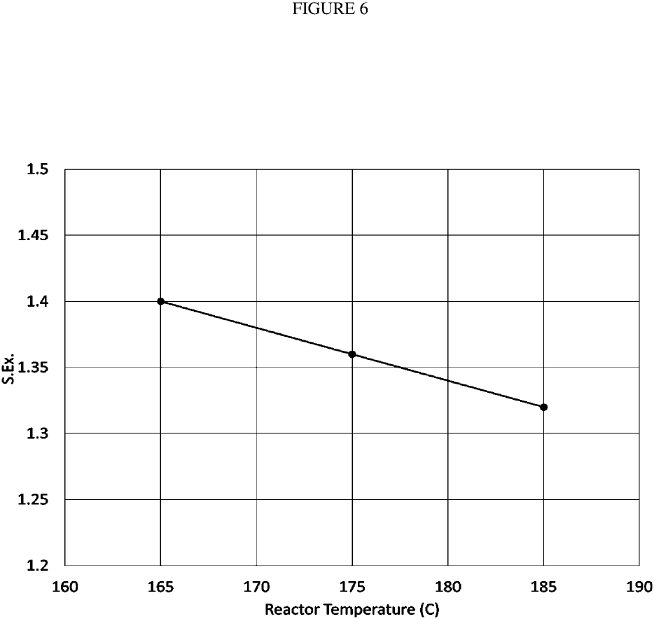

In this Example (Examples 5A-5D), ethylene/1-octene copolymers were made using the above catalyst system in a solution phase polymerization reactor, while changing the temperature in the reactor. The process data and some ethylene copolymer properties are shown in Table 4. The relationship between the polymerization reactor temperature and the stress exponent of the ethylene copolymer is plotted in FIG. 6.

TABLE 4

| Example No. | 5A | 5B | 5C | 5D |
|---|---|---|---|---|
| Reactor 1 (R1) | | | | |
| TSR (kg/hour) | 305 | 300 | 300 | 300 |
| In Reactor Ethylene Concentration (wt%) | 1.29 | 1.19 | 1.09 | 1.3 |
| 1-Octene/ethylene in Fresh Feed (g/g) | 0.25 | 0.25 | 0.25 | 0.25 |
| 1-Octene/ethylene Molar Ratio | 0.0623 | 0.062 | 0.0618 | 0.0619 |
| Primary Feed Temperature (°C) | 30 | 30 | 30 | 30 |
| Mean Reactor Temperature (°C) | 185.2 | 175.0 | 165.0 | 185.0 |
| Ethylene Conversion (%) | 90.06 | 90.03 | 90.07 | 90.04 |
| Hydrogen Feed (ppm) | 8 | 8 | 8 | 8 |
| Catalyst (ppm) to R1 | 0.691 | 0.657 | 0.625 | 0.601 |
| Al (ppm) to R1 | 1.127 | 1.068 | 1.017 | 0.976 |
| Al/Hf (mol/mol) | 43 | 43 | 43 | 43 |
| BHEB/Al (mol/mol) | 0.15 | 0.15 | 0.15 | 0.15 |
| B/Hf (mol/mol) | 1.22 | 1.22 | 1.22 | 1.22 |
| Resin Properties | | | | |
| Density (g/cm³) | 0.912 | 0.9094 | 0.9072 | 0.9124 |
| MI (melt index, I₂ in g/10 min) | 7.40 | 3.96 | 2.26 | 6.71 |
| Melt Flow Ratio (I₂₁/I₂) | 26.1 | 27.8 | 29.7 | 26.1 |
| Mw/Mn | 1.79 | 1.84 | 1.8 | 1.8 |
| Stress Exponent | 1.32 | 1.36 | 1.40 | 1.32 |
| LCBF | 0.0144 | 0.0225 | 0.0318 | 0.013 |

As can be seen from the data in Table 4 and from FIG. 6, as the temperature of the polymerization reactor is increased, the stress exponent of the ethylene/1-octene copolymer is decreased, which indicates a decrease in the amount of long chain branching present in the ethylene/1-octene copolymer.

### Example 6: Maximizing the Stress Exponent in an Ethylene/1-Octene Copolymer

Using the above Examples 1-5 as a guide, several ethylene/1-octene copolymers having relatively high amounts of long chain branching (LCB) were made in a solution phase polymerization reactor with a single site catalyst. From Examples 1-5, a person skilled in the art will recognize that in order to maximize the stress exponent (which is an indicator for long chain branching) of an ethylene/1-octene copolymer with the present solution phase polymerization process and single site catalyst, one should: increase the ethylene concentration in the reactor; and/or decrease the conversion of ethylene in the reactor; and/or decrease the hydrogen concentration in the reactor; and/or decrease the 1-octene:ethylene mass ratio fed to the reactor; and/or decrease the temperature in the reactor (note: conversely, if one wanted to decrease the stress exponent of the ethylene/1-octene copolymer, one would optimize one or more of these variables in the opposite direction). Table 5 shows the reactor conditions used to make ethylene/1-octene copolymers, Examples PE1 to PE7, having an “optimized” stress exponent, in a single reactor (i.e. in the first reactor (R1) of a dual reactor experimental design). The properties of the ethylene copolymers so made, PE1 to PE7 are shown in Table 6. Note that in this context, “optimized” means the stress exponent and hence the long chain branch (“LCB”) content have been maximized using process conditions, so as to improve polymer processability, and potential utility in thermoforming applications, but a person skilled in the art will recognize that “optimized” may also connote a reduction of the stress exponent and hence the LCB content, if for example, polymer toughness properties were to be enhanced, or finally, “optimized” could mean targeting a stress exponent and LCB content which achieves a balance of polymer processability and toughness properties.

TABLE 5

Solution Phase Polymerization Reactor Operating Conditions

| Example No. | PE 1 | PE 2 | PE 3 | PE 4 | PE 5 | PE 6 | PE 7 |
|---|---|---|---|---|---|---|---|
| Reactor 1 (R1) | | | | | | | |
| TSR (kg/hour) | 300.0 | 300.0 | 300.0 | 300.0 | 299.9 | 299.1 | 300.0 |
| In Reactor Ethylene Concentration (wt%) | 4.28 | 4.3 | 3.87 | 4.03 | 3.17 | 3.84 | 3.83 |
| 1-Octene/ethylene in Fresh Feed (g/g) | 0.33 | 0.22 | 0.41 | 0.13 | 0.115 | 0.383 | 0.200 |
| Primary Feed Temperature (°C) | 30.0 | 30.0 | 30.0 | 30.0 | 70.0 | 30.0 | 50.0 |
| Mean Temperature (°C) | 199.6 | 197.6 | 183.6 | 204.5 | 198.7 | 185.3 | 198.3 |
| Ethylene Conversion (%) | 75.0 | 75.0 | 74.9 | 77.5 | 77.5 | 74.9 | 75.0 |
| Hydrogen Feed (ppm) | 0.20 | 0.20 | 0.20 | 0.80 | 0.20 | 0.29 | 0.23 |
| Catalyst (ppm) to R1 | 0.69 | 0.38 | 0.48 | 0.50 | 0.40 | 0.58 | 0.45 |
| Al/Hf (mol/mol) | 40 | 40 | 40 | 40 | 40 | 40 | 40 |
| BHEB/Al (mol/mol) | 0.4 | 0.4 | 0.4 | 0.4 | 0.4 | 0.4 | 0.4 |
| B/Hf (mol/mol) | 1.2 | 1.2 | 1.2 | 1.2 | 1.2 | 1.2 | 1.2 |
| Reactor Residence Time (min) | 1.44 | 1.44 | 1.44 | 1.44 | 1.44 | 1.44 | 1.44 |
| Reactor Pressure (MPa) | 16.0 | 16.0 | 16.0 | 17.0 | 18.0 | 18.0 | 18.0 |

TABLE 6

Ethylene/1-Octene Copolymer Properties

| Example No. | PE 1 | PE 2 | PE 3 | PE 4 | PE 5 | PE 6 | PE 7 |
|---|---|---|---|---|---|---|---|
| Density (g/cm³) | 0.9105 | 0.9163 | 0.9034 | 0.9232 | 0.9226 | 0.904 | 0.9165 |
| Melt Index, I₂ (g/10 min) | 0.6 | 0.2 | 0.23 | 0.32 | 0.27 | 0.24 | 0.21 |
| Melt Index, I₆ (g/10 min) | 3.12 | 1.29 | 1.36 | 1.94 | 1.66 | 1.39 | 1.29 |
| Melt Index, I₁₀ (g/10 min) | 5.79 | 2.46 | 2.56 | 3.73 | 3.26 | 2.69 | 2.53 |
| Melt Index, I₂₁ (g/10 min) | 20 | 9.32 | 9.51 | 13.3 | 11.6 | 9.71 | 9.06 |
| Melt Flow Ratio (I₂₁/I₂) | 33 | 45.8 | 40.4 | 41.6 | 43 | 40.6 | 43.5 |
| Stress Exponent | 1.49 | 1.68 | 1.59 | 1.64 | 1.65 | 1.6 | 1.66 |
| Melt Flow Ratio (I₁₀/I₂) | 9.78 | 12.3 | 11.3 | 11.5 | 12.1 | 11.2 | 12.1 |
| Rheological Properties | | | | | | | |
| Zero Shear Viscosity -190° C. (Pa-s) | 25034 | 99493 | 76250 | 56351 | 71124 | 73899 | 91541 |
| Crossover Frequency -190° C. (rad/s) | 156.54 | 52.75 | 54.268 | 112.49 | 93.411 | 60.663 | 67.247 |
| DRI | 5.66 | 25.9 | 14.1 | 15.7 | 18.29 | 14.6 | 23.51 |
| G′@G″500Pa = | 71.2 | 168.5 | 137.4 | 116.2 | 128.2 | 130.0 | 149.2 |
| Branch Frequency - FTIR | | | | | | | |
| Branch Freq/1000Cs | 16.8 | 12 | 21.4 | 8.5 | 8.5 | 20.8 | 11.8 |
| Comonomer | 1-octene | 1-octene | 1-octene | 1-octene | 1-octene | 1-octene | 1-octene |
| Comonomer Content (mole%) | 3.4 | 2.4 | 4.3 | 1.7 | 1.7 | 4.2 | 2.4 |
| Comonomer Content (wt%) | 12.2 | 8.9 | 15.2 | 6.5 | 6.4 | 14.8 | 8.8 |
| Internal Unsat/100Cs | 0.02 | 0.019 | 0.015 | 0.023 | 0.023 | 0.016 | 0.019 |
| Side Chain Unsat/100Cs | 0.013 | 0.008 | 0.008 | 0.006 | 0.005 | 0.012 | 0.008 |
| Terminal Unsat/100C | 0.01 | 0.009 | 0.008 | 0.01 | 0.008 | 0.008 | 0.009 |
| DSC | | | | | | | |
| First Melting Peak (°C) | 106.04 | 108.88 | 98.14 | 117.18 | 117.09 | 100.51 | 112.18 |
| Second Melting Peak (°C) | – | 114.97 | – | – | – | – | – |
| Heat of Fusion (J/g) | 107.3 | 126.86 | 91.24 | 138.1 | 142.2 | 91.48 | 126.7 |
| Crystallinity (%) | 37 | 43.75 | 31.46 | 47.63 | 49.04 | 31.55 | 43.69 |
| GPC - Conventional | | | | | | | |
| Mₙ | 48702 | 52943 | 56135 | 48826 | 56382 | 60473 | 55565 |
| M_{w} | 90555 | 109126 | 109348 | 97472 | 103470 | 108596 | 106194 |
| M_{z} | 143378 | 180096 | 176814 | 159821 | 168464 | 173263 | 171644 |
| Polydispersity Index (M_{w}/Mₙ) | 1.86 | 2.06 | 1.95 | 2 | 1.84 | 1.8 | 1.91 |
| Long Chain Branching | | | | | | | |
| LCBF | 0.0994 | 0.262 | 0.174 | 0.188 | 0.221 | 0.174 | 0.249 |

Non-limiting embodiments of the present disclosure include the following:

Embodiment A. A solution phase polymerization process for making an ethylene/1-octene copolymer, the process comprising: polymerizing ethylene and 1-octene with a single site catalyst system in a continuous solution phase polymerization reactor at a temperature of at least 140° C. in the presence of hydrogen, and altering the stress exponent of the ethylene/1-octene copolymer by changing one or more of the following conditions in the continuous solution phase polymerization reactor: i) the concentration of ethylene; ii) the percent conversion of ethylene into ethylene/1-octene copolymer; iii) the concentration of hydrogen; iv) the mass ratio of 1-octene:ethylene; v) the temperature; wherein the single site catalyst system comprises: a) a metallocene catalyst having the formula:

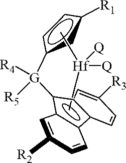

wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand; and b) a catalyst activator.

Embodiment B. The solution phase polymerization process of Embodiment A wherein the ethylene feed concentration to the continuous solution phase polymerization reactor is from 9 to 26 weight percent of ethylene in the feed solvent.

Embodiment C. The solution phase polymerization process of Embodiment A or B wherein the pressure in the continuous solution phase polymerization reactor is from 10.3 to 31 MPa.

Embodiment D. The solution phase polymerization process of Embodiment A, B, or C wherein the residence time of the continuous solution phase polymerization reactor is from 0.5 to 5 minutes.

Embodiment E. The solution phase polymerization process of Embodiment A, B, C, or D wherein the ethylene/1-octene copolymer has a melt index, I₂ of from 0.1 to 5.0 g/10 min.

Embodiment F. The solution phase polymerization process of Embodiment A, B, C, or D wherein the ethylene/1-octene copolymer has a melt index, I₂ of less than 2.0 g/10 min.

Embodiment G. The solution phase polymerization process of Embodiment A, B, C, or D wherein the ethylene/1-octene copolymer has a melt index, I₂ of less than 1.0 g/10 min.

Embodiment H. The solution phase polymerization process of Embodiment A, B, C, D, E, F or G wherein the ethylene/1-octene copolymer has a density of from 0.865 to 0.930 g/cm³.

Embodiment I. The solution phase polymerization process of Embodiment A, B, C, D, E, F, or G wherein the ethylene/1-octene copolymer has a density of from 0.895 to 0.930 g/cm³.

Embodiment J. The solution phase polymerization process of Embodiment A, B, C, D, E, F, G, H, or I wherein the catalyst activator comprises:
i) an ionic activator,
ii) an alkylaluminoxane, and
iii) a hindered phenol compound.

Embodiment K. The solution phase polymerization process of Embodiment A, B, C, D, E, F, G, H, I, or J wherein the metallocene catalyst has the formula:

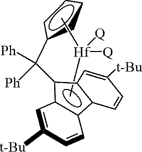

wherein Q is independently an activatable leaving group ligand.

Embodiment L. The solution phase polymerization process of Embodiment A, B, C, D, E, F, G, H, I, J, or K wherein the continuous solution phase polymerization reactor is at a temperature of at least 160° C.

### INDUSTRIAL APPLICABILITY

Long chain branching is known to affect the performance properties of ethylene copolymers. A solution phase polymerization process is provided in which the amount of long chain branching present in an ethylene/1-octene copolymer is controlled.

1. A solution phase polymerization process for making an ethylene/1-octene copolymer, the process comprising:
polymerizing ethylene and 1-octene with a single site catalyst system in a continuous solution phase polymerization reactor at a temperature of at least 140° C. in the presence of hydrogen, and
altering the stress exponent of the ethylene/1-octene copolymer by changing one or more of the following conditions in the continuous solution phase polymerization reactor:
i) the concentration of ethylene;
ii) the percent conversion of ethylene into ethylene/1-octene copolymer;
iii) the concentration of hydrogen;
iv) the mass ratio of 1-octene:ethylene;
v) the temperature;
wherein the single site catalyst system comprises:
a) a metallocene catalyst having the formula: 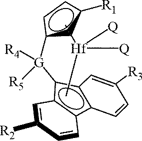
wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋ ₂₀ hydrocarbyl radical, a C₁₋₂₀ alkoxy radical or a C₆₋₁₀ aryl oxide radical; and Q is independently an activatable leaving group ligand; and
b) a catalyst activator.

2. The solution phase polymerization process of claim 1 wherein the ethylene feed concentration to the continuous solution phase polymerization reactor is from 9 to 26 weight percent of ethylene in the feed solvent.

3. The solution phase polymerization process of claim 1 wherein the pressure in the continuous solution phase polymerization reactor is from 10.3 to 31 MPa.

4. The solution phase polymerization process of claim 1 wherein the residence time of the continuous solution phase polymerization reactor is from 0.5 to 5 minutes.

5. The solution phase polymerization process of claim 1 wherein the ethylene/1-octene copolymer has a melt index, I₂ of from 0.1 to 5.0 g/10 min.

6. The solution phase polymerization process of claim 1 wherein the ethylene/1-octene copolymer has a melt index, I₂ of less than 2.0 g/10 min.

7. The solution phase polymerization process of claim 1 wherein the ethylene/1-octene copolymer has a melt index, I₂ of less than 1.0 g/10 min.

8. The solution phase polymerization process of claim 1 wherein the ethylene/1-octene copolymer has a density of from 0.865 to 0.930 g/cm³.

9. The solution phase polymerization process of claim 1 wherein the ethylene/1-octene copolymer has a density of from 0.895 to 0.930 g/cm³.

10. The solution phase polymerization process of claim 1 wherein the catalyst activator comprises:
i) an ionic activator;
ii) an alkylaluminoxane; and
iii) a hindered phenol compound.

11. The solution phase polymerization process of claim 1 wherein the metallocene catalyst has the formula: 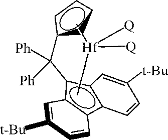
wherein Q is independently an activatable leaving group ligand.

12. The solution phase polymerization process of claim 1 wherein the continuous solution phase polymerization reactor is at a temperature of at least 160° C.
